(19) United States
(12) Patent Application Publication
(10) Pub. No.: US 2023/0394472 A1
(43) Pub. Date: Dec. 7, 2023

(54) Federated Currency Payment Exchange System

(71) Applicant: Israel Landau, Henderson, NV (US)

(72) Inventor: Israel Landau, Henderson, NV (US)

(21) Appl. No.: 18/032,805

(22) PCT Filed: Oct. 19, 2021
(86) PCT No.: PCT/US2021/055701

§ 371 Date: Apr. 20, 2023

(51) Int. Cl. G06Q 20/38; G06Q 20/20; G06Q 20/10; G06Q 20/40

(52) U.S. Cl. CPC G06Q 20/381; G06Q 20/20; G06Q 20/10; G06Q 20/40

(57) ABSTRACT

A federated currency payment exchange system of at least one of barter currency and digital currency includes a computer-executed federated electronic trade value transfer system to receive two requests. A first request is made to transfer a specified amount of currencies of at least one of barter currency and digital currency from the first currency account to a second currency account of at least one of barter currency and digital currency associated with a second currency member. A second request is made to perform a second transfer to transfer a specified amount of global currency of at least one of barter currency and digital currency from the first currency account to a global account of at least one of barter currency and digital currency associated with a merchant. The global currency is separately and distinctly managed independently of the community currencies.

### TECHNICAL FIELD

Aspects of the present disclosure relate to currencies payment exchange systems, in particular, to a federated currencies payment exchange system with of at least one of barter currency and digital currency.

### BACKGROUND

Computerized cash payment exchange systems are not new, and with the growing level of commerce among differing financial institutions, the near instantaneous exchange of cash-based financial transactions has become commonplace. Despite these advances in the computerized payment exchange systems, none of these systems are equipped to handle payment exchanges which are not purely cash based. More specifically, the incorporation of non-cash elements into an otherwise purely-cash transaction creates insurmountable challenges for the typical cash-based payment systems.

### SUMMARY

According to one aspect of the present disclosure, a federated currency payment exchange system with at least one of barter currency and digital currency includes a computer-executed federated electronic trade value transfer system to receive two requests. From a first computing device associated with a first currency account of at least one of barter currency and digital currency of a first currencies member, a first request is made to transfer a specified amount of currencies of at least one of barter currency and digital currency from the first currency account to a second currency account of at least one of barter currency and digital currency associated with a second currency member, and to facilitate transferring of the specified amount of currency of at least one of barter currency and digital currency according to the first request. From the first computing device, a second request is made to perform a second transfer to transfer a specified amount of global currency of at least one of barter currency and digital currency from the first currency account to a global account of at least one of barter currency and digital currency associated with a merchant, and to facilitate transferring of the specified amount of global currency according to the second request. The global currency is separately and distinctly managed independently of the community currencies. The payment system using Barter currency and/or Digital currencies includes electronic payment readers comprising a parasitic software application, a regular software application and a host application that answers the phone calls from those terminals. The Bartering systems and/or Digital currencies payment exchange systems communicates via shared regular centralized databases and/or decentralized ledgers known as blockchains.

### BRIEF DESCRIPTION OF THE DRAWINGS

The various features and advantages of the technology of the present disclosure will be apparent from the following description of particular embodiments of those technologies, as illustrated in the accompanying drawings. In the drawings the like reference characters may refer to the same parts throughout the different views. The drawings are not drawn to scale. Rather, the drawings depict only typical embodiments of the present disclosure and, therefore, are not to be considered limiting in scope. Throughout this document barter currency is the trade value of barter in currency.

FIG. 1 illustrates an example currency payment exchange system with at least one of barter currency and digital currency according to one embodiment of the present disclosure.

FIG. 2 illustrates several components of the example electronic trade value request, approval, and actual transfer system according to one embodiment of the present disclosure.

FIG. 3 illustrates several components of the example point of sale (POS) terminal according to one embodiment of the present disclosure.

FIG. 4 illustrates an example federated electronic trade value transfer system according to one embodiment of the present disclosure.

FIG. 5 illustrates an example flow diagram that may be performed by the currency payment exchange system with at least one of barter currency and digital currency according to one embodiment of the present disclosure.

FIG. 6 illustrates an example representative hardware environment for practicing the present disclosure.

### DETAILED DESCRIPTION

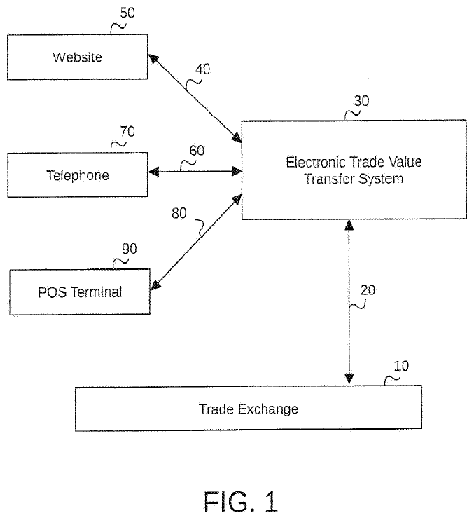

FIG. 1 illustrates an example currency payment exchange system with at least one of barter currency and digital currency according to one embodiment of the present disclosure. The currency payment exchange system with at least one of barter currency and digital currency includes a trade exchange 10 in communication with an electronic trade value transfer system 30 via a data communication link 20. The electronic trade value transfer system 30 is also in communication with a website 50, a telephone 70, and a point of sale (POS) terminal 90 via a first communication link 40, a second communication link 60, and a third communication link 80. In one embodiment, the trade exchange 10 includes a clearing house.

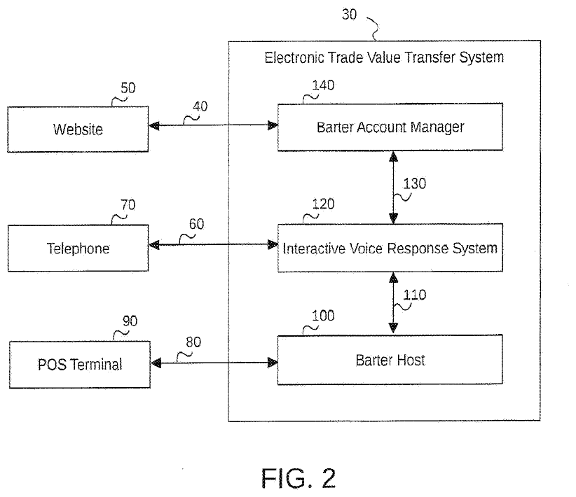

FIG. 2 illustrates several components of the example electronic trade value transfer system 30 according to one embodiment of the present disclosure. The electronic trade value transfer system 30 includes a barter currency and/or Digital currency host 100, an interactive voice response system 120, and a Barter currency and/or Digital currency account manager 140. The barter currency and/or digital currency host 100 is in communication with one or more POS terminals 90 via third communication link 80, while the interactive voice response system 120 is in communication with one or more telephones 70 via second communication link 60, and the barter currency and/or digital currency account manager 140 is in communication with one or more websites 50 via first communication link 40.

In one embodiment, the first communication link 40 and/or third communication link 80 comprises a hypertext communication link, such as the Internet. In other embodiments, first communication link 40 and/or third communication link 80 may include a cellular network link in which website 50 includes a mobile app that is executed on a wireless device, such as a cell phone. In one embodiment, second communication link 60 may include a public switched telephone network (PSTN), or other suitable communication network that manages voice call sessions. The barter currency and/or digital currency host 100 provides automated telephonic trade value transfer authorizations via shared databases and/or blockchains 110. The interactive voice response system 120 is coupled to barter currency and/or digital currencies account manager 140 via shared databases and/or blockchains 130.

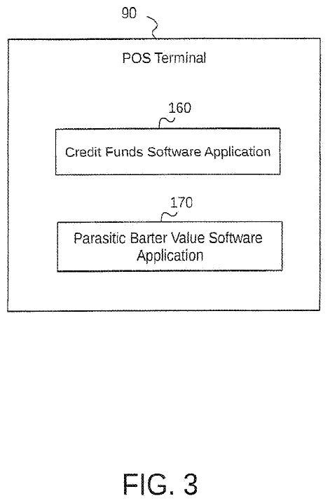

FIG. 3 illustrates several components of the example POS terminal 90 according to one embodiment of the present disclosure. The POS terminal 90 includes a resident credit funds software application 160 and a parasitic barter currency and/or digital currencies value software application 170. In one embodiment, the credit funds software application 160 and/or the parasitic barter currency and/or digital currencies value software application 170 may be downloaded into the POS terminal 90 from a remotely configured repository, such as the electronic trade value transfer system 30 via a communication link, such as the Internet.

The credit funds software application 160 and/or the parasitic barter currency and/or digital currencies value software application 170 may include instructions that may be executed in an operating system environment, such as a Microsoft Windows™ operating system, a Linux operating system, or a UNIX operating system environment. Although the credit funds software application 160 and/or the parasitic barter currency and/or digital currencies value software application 170 is shown and described as a computer-based design incorporating instructions stored in a memory and executed by a processing system, it should be understood that the credit funds software application 160 and/or the parasitic barter currency and/or digital currencies value software application 170 may be a distributed computing system embodied on multiple computing systems that communicate among one another using standard communication architectures (e.g., Ethernet, etc.).

The memory of the computing system comprises a non-transitory computer readable medium including volatile media, nonvolatile media, removable media, non-removable media, and/or another available medium. By way of example and not limitation, the memory may include computer storage media, such as non-transient storage memory, volatile media, nonvolatile media, removable media, and/or nonremovable media implemented in a method or technology for storage of information, such as computer readable instructions, data structures, program modules, or other data. The memory also stores data used for operation of the credit funds software application 160 and/or the parasitic barter currency and/or digital currencies value software application 170.

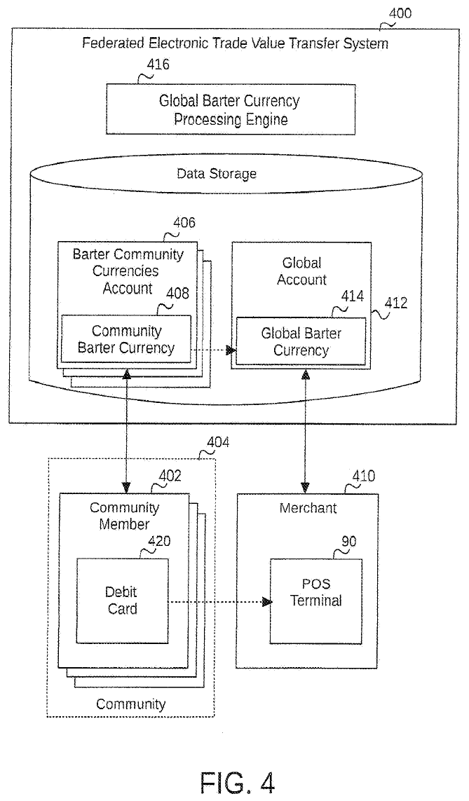

FIG. 4 illustrates an example federated electronic trade value transfer system 400 according to one embodiment of the present disclosure. The federated electronic trade value transfer system 400 is similar to the electronic trade value transfer system 30 of FIGS. 1-4 with the exception that the federated electronic trade value transfer system 400 includes multiple barter currency and/or digital currencies members 402 forming a barter currency and/or Digital currencies community 404 with each barter currency and/or digital currencies member 402 having a barter currency and/or digital community currencies account 406. Using the barter currency and/or digital community currencies account 406, barter currency and/or digital members may trade or otherwise perform financial transactions with one another using barter currency and/or digital community currencies 408 that is unique to that barter currency and/or digital currency community 404. Barter currency and/or digital currency members 402 of the barter currency and/or digital currency community 404 may also conduct financial transactions with other entities, such as a merchant 410 having a global account 412 for storing a global barter currency and/or digital currency 414, using a global barter currency and/or digital currency processing engine 416.

Although the barter currencies member and/or digital currencies member 402 is described herein as an individual, it should be appreciated that the barter currency and/or digital currency member 402 may also be considered to include a computing device, such as a personal computer, smartphone, tablet, and the like, that may be used to communicate with and transfer information to and from the federated electronic trade value system 400.

In general, a barter community currencies and/or digital community currencies 408 may include any type of barter currency and/or digital currency that, among other things, provides its identified barter currency and/or digital currency members with a steady extra income, optionally provides voting rights over a group fund, and provides adequate means for transparency and accountability of the barter community currencies and/or digital community currencies 408 used by the barter currency members and/or digital currency members 404.

The right to mint currency has been historically limited to a small portion of the population because of difficulties in establishing counterfeit-proof currency of concrete value. By linking real-world identities to database and/or blockchain entries, it is possible to extend this right to arbitrary communities (e.g., groups) in a manner that protects against fraud while preserving fair market valuation for arbitrary currencies.

Traditional companies authenticate the identities of their employees, they provide them with a living wage, give out shares with voting rights, and are required by law to provide financial transparency and accountability. As such, barter currency and/or digital currencies 408 may be well adapted for use with companies to use with their employees. In one aspect, the barter currency and/or digital currencies 408 may be viewed as establishing more efficient, transparent, borderless, on-the-fly companies.

The inventor considers the importance of a steady extra income to be self-evident, ever increasing in necessity, and therefore integral to the functioning of any modern monetary system. The barter currency and/or digital currency members 402 of a Barter community currency and/or Digital currency community will 408 all mint currencies (e.g., trade dollars, barter currency and/or digital currency dollars, etc.) at an equal rate. This rate may change and may approximate an extra steady income for each group member 402. One way to mint barter currency and/or digital currency is by giving the barter currency and/or digital currency broker the ability to collectively advocate for the barter currency and/or digital currency member's data rights and his or her right to be compensated for the use of their data, which is their property. Barter currency and/or digital currency Brokers can also be Data Brokers who can establish and enforce data property rights under laws such as the California Consumer Privacy Act (CCPA), which went into effect on Jan. 1, 2020. Barter community currencies and/or digital currency communities knows that barter currency and/or digital currency members are also consumers, who should have ownership over their personal data and should be compensated for its use.

In currencies that provide a steady extra income, the equivalent of traditional counterfeiting is the creation of false identities, which may include one known as a False Identity attack. In some embodiments, the value of a barter community currencies and/or digital community currencies 408 on the free market would in part be derived from its effectiveness in handling such false identity attacks. If groups restrict membership, ensure it is publicly auditable, do proper vetting of new barter currency members and/or digital currency members, and keep the group size small, the False Identity attack may be of little concern. It is when groups allow arbitrary membership that combating the False Identity attack becomes relatively more important for maintaining the integrity of the barter currency community and/or digital currency community 408. Potential false identity attack mitigation techniques may include applying a cost to be associated with joining the barter currency community and/or digital currency community 404, staying in the Barter currency community and/or Digital currency community 404, and leaving the barter currency community and/or digital currency community 404 due to misbehavior, proof of individuality, criminal punishment, near field communications (NFC) authentication systems (e.g., e-passport), to name a few.

Communities 404 may be encouraged to implement a group fund to which members automatically contribute a percentage of their extra income. Individual barter currency members and/or digital currency members 402 may be able to opt-out of these contributions, but in doing so they would lose their ability to vote on how the group funds are used. barter currency and/or digital members 402 vote using their barter currency and/or digital community currencies 408. This provides barter currency members and/or digital currency members 402 with a means to signal the importance an issue has to them. Conventional voting techniques including “$1=1 vote” fail to acknowledge the asymmetry that exists in the creation of fiat currencies and may be considered, therefore, unfair. Communities 404, however, may extend the right to mint barter currency and/or digital community currency 408 equally to every barter currency member and/or digital currency member 402 of the barter currency community and/or digital currency community 404, and therefore make this attractive system of voting possible while preserving fairness. The purpose of a group fund is to provide the barter currency community and/or digital currency community 404 with a means to invest in the barter currency and/or digital currency itself (i.e., value creation of some sort). It is believed such a scheme will result in the creation of more value that is properly incentive aligned with the interests of the barter currency and/or digital currency itself, and therefore may have pro-social consequences in addition to increasing the value of the barter currency and/or digital's currency.

Barter currency and/or digital currencies 408 can be used to monetize virtually anything of value; in fact, they may be well suited for doing so. The inspiration for this idea came from a desire to make pro-social value creation easier to achieve without resorting to advertising, outside investment, or donations. Privacy-conscious developers can finance their efforts by monetizing any activity their product or service facilitates. Developers of various products or services can form a barter currency community and/or digital currency community 404 and choose to accept their barter currency and/or digital's currency 408 for arbitrary features. For example, the sending of secure messages longer than X characters or to more than Y members may be based upon a prorated Z rate. Such mechanisms have the added benefit of protecting users from spam. For example, while it may be relatively inexpensive to send messages to your friends, it may be more expensive to spam the world.

Student researchers or professors can finance their research by forming communities 404 (e.g., classrooms, departments, universities, etc.) and charging access to the value they create (research papers, their professional time, etc.).

Game developers can finance the development of their next game (e.g., big hit) by forming a barter currency community and/or digital currency community 404, and accepting their barter currency and/or digital's currency 408 for in-game assets. Although this model is already partially used via in-app purchases, current implementations involve a middleman who takes a cut, and their virtual “gems” cannot be exchanged for monetary value outside the game.

A town, city, state, or country can provide its barter currency and/or digital community 404 with an extra income that is backed by the value created by that barter currency and/or digital currency 404.

As is described herein above, any value-creation activity can now be easily financed without annoying your own customers with advertisements or betraying their privacy.

Regarding the issuance of multiple, differing Barter currency and/or Digital currencies, consider the examples above were they to restrict themselves to traditional currencies (e.g., currencies, fiat money, etc.). Researchers would have to resort to traditional grant writing and other means of extracting money out of others before they could begin work. If instead they formed a barter community and/or digital community 404 issuing its own currency (e.g., Academic Barter Dollars and/or Academic Digital Dollars), they would be able to provide others with a barter currency and/or digital currency that represents the barter's community and/or digital's community value and potential as human beings. Exchange this X barter dollar and/or X digital dollar for some other Y barter dollar and/or Y digital dollar of value that they could then use to finance their research. In the future, the Academic Barter Dollar and/or Academic Digital dollar may become very valuable such that it represents 1000+ respected researchers who accept it as payment for their time, early access to research results, papers, and the like. It may also provide these academicians with something vital, namely a steady extra income (early tenure). The freedom to think on matters other than survival is no longer restricted to nobility. The market, in turn, provides them with feedback on their performance through the price of Academic Barter Dollar and/or Academic Digital Dollar.

Individuals can receive multiple extra income by being part of multiple communities 404. Most newly formed groups will be unable to provide all their barter currency members and/or digital currency members 402 with an extra income, so an individual may be able to accumulate an extra income for themselves by being accepted into multiple communities 404. In exchange for membership, most communities 404 will likely expect their barter currency members and/or digital currency members 402 to contribute value in some way, and most communities 404 will likely be capable of expelling barter currency members and/or digital currency members 402 whom they've decided are abusing the system.

It may cause relatively little hassle to hold many different barter currencies and/or digital currencies 408. At least, there may be no reason for it to be. In this era of fast-paced technology and Artificial Intelligence (AI), software can make conversions between different “currencies” almost as seamless as if no conversion took place. This includes the use of parallel blockchains or parachains. Parachains are those heterogeneous blockchains that are connected to a relay chain. They are interoperable with the relay chain network and other parachains. A relay chain is an interoperable blockchain that can connect multiple blockchains, enabling them to communicate with each other.

Once the barter community currency and/or digital community currency 408 is deposited into the barter currency member's account and/or digital currency member's account 406, he or she will have the option to use the barter community currency and/or digital community currency 408 for conducting financial transactions with other barter currency members and/or digital currency members 402 of the barter currency community and/or digital currency community 404, or convert them into global barter currency and/or global digital currency 414, by using, among other things, a debit card 420 that includes information for identifying and authenticating the barter currency member and/or digital currency member 402. For example, the debit card 420 may be presented to a POS terminal 90 at a merchant 410 for purchasing one or more items from the merchant 410. The POS terminal 90 may, using the parasitic barter currency and/or digital currency trade software application 170 installed on the POS terminal 90, communicate with the federated electronic trade value system 400 to debit barter currency community currencies and/or digital currency community currencies 408 from the member barter currency community currencies account and/or member digital currency community currencies account 406 and credit a global barter currency account and/or global digital currency account 412 of the merchant 410.

In one embodiment, the transaction may be facilitated using a global processing engine 416 stored in the federated electronic trade value system 400. The engine 416 includes instructions stored in a memory and executed by a processing system (e.g., one or more microprocessing units). The engine 416 manages financial transactions for trading barter community currency and/or digital community currency 408 with global barter currency and/or digital currency 414. For example, the barter currency member and/or digital currency member 402 may conduct a financial transaction with the merchant 410 to purchase one or more items for a specified amount of global barter currency and/or global digital currency 414. In this particular example, the global processing engine 416 may perform certain features so that this financial transaction may be consummated. One example of a feature that may be performed by the global processing engine 416 includes calculating an exchange rate (e.g., ratio) of a current value of the barter community currency and/or digital community currency 408 to the global barter currency and/or global digital currency 414 to pay for the items. Another example feature may include determining a processing fee and/or transaction fee to be assessed to the barter currency member and/or digital currency member 402 for performing the transaction. That is, the global processing engine 416 may assess a certain monetary amount (e.g., a percentage of the overall amount, a flat fee, etc.) to be charged to the barter currency member and/or digital currency member 402 for performing the financial transaction.

In one embodiment, the merchant 410 may be a barter currency exchange and/or digital currency exchange. In such a case, one feature provided by the engine 416 may include verifying that the barter currency and/or digital currency transaction has successfully completed, prior to initiating a transfer of assets or services, from an account of the barter currency exchange and/or digital currency exchange to the account of the barter currency member and/or digital currency member 402.

The barter currency exchange and/or digital currency exchange generally includes a business that trades assets for other assets, services for services or other barter currency and/or digital currency. In one embodiment, the barter currency exchange and/or digital currency exchange includes a currency exchange that performs online transactions via a publicly available communication network, such as the Internet. Examples of barter currency and/or digital currency exchanges may include the IMS™, ITEX™ and UC™ Barter currency and/or Digital currency exchanges.

Thus as described above, the federated electronic trade value system 400 is federated in that barter currency members and/or digital currency members 402 may be able to conduct financial transactions locally with one another using barter community currency and/or digital community currency 408, in addition to conducting a wide range of financial transactions using global barter currency and/or global digital currency 414. Barter currency and/or digital currency 408 are built on each community's permissioned centralized highly secure databases, with full transaction history and balance, as well as providing means to transfer value globally. Because it is intended to address a global audience, the parasitic terminal software that implements this novel non-cash payment system is open source; it is designed so that anyone can build on it, and millions of people can depend on it for their financial needs. Imagine an open, interoperable ecosystem of financial services that developers and organizations will build to help people and businesses hold and transfer global barter currency and/or global digital currency 414 for everyday use. Open-source licenses grant broad rights to modify, compile, distribute, and use the software, and are only free to use if: you do not enforce any right against inventor, you do not enforce any patent right against another party, you do not oppose this investor's patents or copy inventor's designs. Since anyone can legally appropriate OSS technologies in closed-source products with 100% identical functionalities. This Patent can protect the functionalities (APIs) and the underlying technologies. When a community builds a new technology, it must protect it by obtaining and asserting patent rights. This is the only hope, the community has, to defend its creation and its members from industry giants. With the proliferation of smartphones and wireless data, increasingly more people will be online and able to access barter community currency and/or digital community currencies 408 as well as global barter currency and/or global digital currency 414 through these new services. To enable the federated ecosystem to achieve this vision over time, the barter currency system and/or digital currency system has been built from the ground up to prioritize scalability, security, efficiency in storage and throughput, and future adaptability.

It may be important to mention that barter community currency and/or digital community currencies 408 are not money transmitting cryptocurrencies within the meaning and intent of FinCEN. As such, the barter community currency 408 is not subject to money transmitter regulations and should not be subject to new regulations designed to reign-in cryptocurrencies. In March of 2013 FinCEN issued new guidance to clarify the applicability of the BSA regarding persons/entities that are “creating, obtaining, distributing, exchanging, accepting, or transmitting crypto currencies.” The FinCEN guidelines further stated that persons/entities that obtain crypto currencies to purchase goods or services do not fit into the regulatory definition of a money transmitter. However, FinCEN went on to say that if the person/entity engaged in “the exchange of crypto currency for real currency” (i.e., the crypto currency is redeemable for cash), the person/entity would be considered a money transmitter. Research of the March 2013 FinCEN guidelines have concluded that unless the barter currency organization and/or the digital currency organization itself is trading or redeeming trade currencies for real cash, the barter currency organization and/or the digital currency organization would not fall under this new expanded guidance.

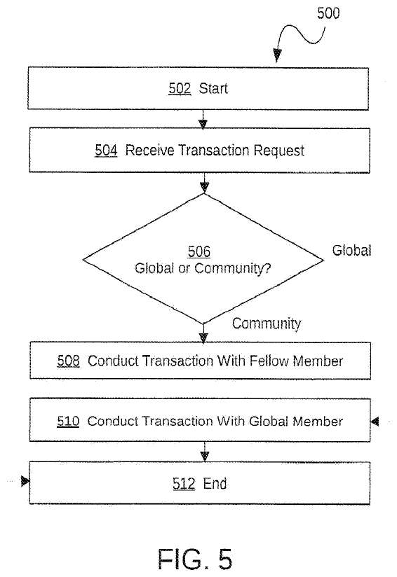

FIG. 5 illustrates an example flow diagram 500 that may be performed by the federated electronic trade value transfer system according to one embodiment of the present disclosure. The process starts (step 502) when the customer initiates a barter currency transaction and/or digital currency transaction with the merchant. Thereafter, the electronic trade value transfer system 400 receives a transaction request (step 504). The transaction request may include information to identify a barter community currency account and/or digital currency community account 406 associated with a barter currency member and/or digital currency member, and information to identify a global barter currency account and/or global digital currency account 412 associated with a merchant 410. In one embodiment, the electronic trade value transfer system 400 may identify the barter community currency account and/or digital community currencies account 406 by receiving account identification and/or authorization number (e.g., passcode) information from a payment card (e.g., debit card 420) having a magnetic strip or embedded chip that stores the information.

The account number and associated authorization number may be entered through the POS terminal 90, the website 50, telephone 70, or any combination thereof. In one embodiment, the account number and authorization number may be entered into a mobile app executed on a mobile phone to authorize the barter currency transaction and/or digital currency transaction between the customer and the merchant.

The electronic trade value transfer system 400 then determines (step 506) whether the transaction request is directed to another fellow barter community currency account and/or digital community currency account 406 (e.g., local account) or a global account 412. If the transaction request is directed to another fellow barter community currency account and/or digital community currencies account 406, processing continues at step 508; otherwise, processing continues at step 510.

The electronic trade value transfer system 400 conducts (step 508) a financial transaction between the barter currency member and/or digital currency members 402 of the barter currency community and/or digital currency community 404. For example, the electronic trade value transfer system 400 may communicate with a participating data miner associated with the barter currency community and/or digital currency community (e.g., digital assets) to facilitate transferal of the barter currency and/or digital currency. It may be important to note that, the number of barter currency members and/or digital currency members 402 of the barter currency community and/or digital currency community may be relatively small (e.g., 10-10,000 members) such that the transaction may be validated in a relatively short time frame.

That is, because the barter currency and/or digital currency 408 of the barter currency community and/or digital currency community is separate and distinct from that of the global barter currency and/or global digital currency 414, validation of each transaction can be resolved independently of how transactions are resolved at the global level such that they can be conducted in a relatively short time.

The electronic trade value transfer system 400 conducts (step 510) a global financial transaction between the barter currency member and/or digital currency member 402 and the merchant 410 or other entity that possesses an account with the electronic trade value transfer system 400. In this regard, the electronic trade value transfer system 400 may determine whether the transaction can be authorized, and if so, the electronic trade value transfer system 400 debits the member account and credits the merchant account. In one embodiment, the barter currency account manager and/or digital currency account manager 140 signals the transaction completion by providing a confirmation code to the merchant and customer via either the website 50, POS terminal 90, or telephone 70.

In one embodiment, the electronic trade value transfer system 400 may calculate an exchange rate of a current value of the barter community currency and/or digital community currency 408 versus the current value of the global barter currency and/or global digital currency 414, and apply the calculated exchange rate to the transaction. In another embodiment, the electronic trade value transfer system 400 may determine a processing fee or a transaction fee to be assessed to the barter currency member and/or digital currency member 402 for performing the transaction. In yet another embodiment, the barter currency member and/or digital currency member 402 may use a debit card 420 that interacts with a POS terminal managed by the merchant such that the parasitic barter currency value software application and/or digital currency value software application 170 installed on the POS terminal 90 communicates with the electronic trade value transfer system 400 for conducting the transaction.

Thereafter, the process ends (step 512).

The POS terminal 90 may include an electronic payment device reader, such as a swipe card reader, electronic smart card reader, retinal identification reader, fingerprint identification reader, implant chip identification reader, radio frequency identification reader, global positioning system identification reader, and combinations thereof. Payment devices may include swipe card, smart card, radio frequency identification device, retinal identification device, fingerprint identification device, implant chip identification device, global positioning system identification device, personal computer, personal data assistant device, scanner, automated teller machine, electronic wallet, and combinations thereof.

In one embodiment, the electronic payment devices reader has physical location substantially on a kiosk. An example barter currency account manager and/or digital currency account manager 140 includes a barter currency payment exchange server and/or digital currency payment exchange server including the barter currency and/or digital currency payment exchange online interactive voice response system. An example implementation of the barter currency and/or digital currency host 100 includes a XYZ Software host resident enhanced point of sale terminal application for credit card transactions that comprises the parasitic barter currency value and/or digital currency value software application 170. An example barter currency website 50 is available from www.BarterofAmerica.com

In one embodiment, the barter currency account manager and/or digital currency account manager 140 includes a mapper loader interface to a barter currency and/or digital currency payment exchange 10. Mapper tools enable the association of fields from different data bases. An exemplary embodiment of a mapper is that provided by the Open DataBase Connectivity (ODBC) toolset that uses any compliant ODBC driver, widely available for many databases including Microsoft Access. This mapper uses stored procedures and enables the crosswalk of information from dynamic data bases to map elements. In an exemplary embodiment, merchants obtain one or more POS terminal 90 from manufacturers such as Verifone or Zon. These POS terminals (e.g., Verifone Tranz or Zon Jr. XL terminals) comprise a microprocessor which, when in data communication with a barter currency account and/or digital currency account manager 140 requests authorization of the amount of trade value transfer. The microprocessor transmits information corresponding to the customer and merchant account identification information. The merchant enters the amount at a keyboard and the barter currency and/or digital currency account manager approves or denies the transaction.

One example embodiment implements a parasitic barter currency and/or digital currency value software application 170 that augments or re-purposes the POS terminal 90 and other widely available transaction devices. When the POS terminals have been reprogrammed, merchants can enter a command at a keyboard of the POS terminal 90 to connect with the barter currency and/or digital currency account manager 140 and initiate a routine resulting in the transfer of barter currency and/or digital currency trade values. The parasitic barter currency and/or digital currency value software application 170 can reside on a POS terminal 90 without affecting a resident application for credit card transactions.

In one embodiment the parasitic barter currency and/or digital currency value software application 170 accepts a payment device then requests customer identification information to verify the customers right to use the card. If the customer's right to use the payment device is verified, information associated with the trade balance and available trade balance will be available on demand via the parasitic barter currency and/or digital currency value software application 170. The point-of-sale terminal 90 then connects to the barter currency and/or digital currency host 100 and completes the transaction. The barter currency and/or digital currency host 100 formats the response including receipt information and transmits the response to the POS terminal 90. The receipt information includes official time and date information, the information requested together with an amount of any transaction fees due. The available trade balance items include any available trade credit. The credit card transaction for the POS terminal 90 includes trade balance, available trade balance, any fees due, credit line and pending purchases. The regular transaction is expected to complete more rapidly than the parasitic transaction since the barter currency and/or digital currency host 100 often does not need to format a receipt. The barter currency and/or digital currency host 100 transmits the transaction information and the POS terminal 90 stores the location information and formats the complete receipt.

In the above embodiment, the barter currency and/or digital currency host 100 receives and sends all needed data to the POS terminals 90 and interacts with the interactive voice response system 120 and barter currency and/or digital currency account manager 140 via Open Database Connectivity. The barter currency and/or digital currency host program includes a separate window for each supported phone line and modem, software enabling the regular 160 and parasitic 170 terminal applications to be downloaded into the POS terminals 90, and may manage multiple telephone lines concurrently. The barter currency and/or digital currency host 100 is implemented for any suitable operating system, and may support multi-port boards, such as the widely used Digi Classic Boards.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., hard disk drive), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

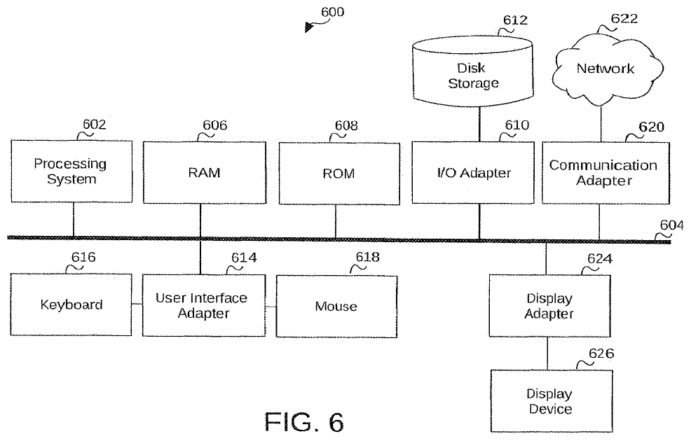

FIG. 6 illustrates an example representative hardware environment 600 for practicing the present invention according to one embodiment of the present disclosure. In particular, the representative hardware environment 600 may execute the electronic trade value transfer system 30, 400 or other executable software code as described above. The representative hardware environment 600 includes a processing system 602, which may include one or more microprocessors, and a number of other units interconnected via a system bus 604. The processing system 602 may include other circuitry not shown herein, which may include other types of circuitries typically found in a microprocessor, such as an execution unit, bus interface unit, Arithmetic Logic Unit (ALU), and the like. In some cases, the processing system 602 may be embodied in a single Integrated Circuit (IC) chip.

The representative hardware environment 600 includes a Random-Access Memory (RAM) 606 and a Read Only Memory (ROM) 608. Also included are an I/O adapter 610 for connecting peripheral devices such as disk storage units 612 to the bus 604, a user interface adapter 614 for connecting a keyboard 616, a mouse 618 and/or other user interface devices, such as a touch screen device (not shown) to the bus 604. The I/O adapter 610 may be of any of several well-known types, including a serial interface, a parallel interface, a Universal Serial Bus (USB″) and the like.

Further included in the representative hardware environment 600 may be a communication adapter 620 for connecting the representative hardware environment 600 to a communication network 622, such as the Internet. For user interface purposes, the representative hardware environment 600 may include a display adapter 624 for connecting the system bus 604 to a display device 626. In an alternative embodiment, the representative hardware environment 600 may include additional display adapters (not shown) for connecting additional display devices (not shown) to the representative hardware environment 600. It will be appreciated that, although many processing systems 602 may have many or all of these elements, each and every element described above is not required in order for a device to qualify as a representative hardware environment.

With respect to the above description, it is to be realized that although embodiment of specific material, representations, iterations, applications, configurations, networks, and languages are disclosed, those enabling embodiments are illustrative and the optimum relationship for the parts of the invention may include variations in composition, form, protocols, function, and manner of operation, which are deemed readily apparent to one skilled in the art in view of the present disclosure. All relevant relationships to those illustrated in the drawings and the specification are intended to be encompassed by the claims of the present disclosure. Therefore, the foregoing is considered as merely illustrative of the principles of the present disclosure. Numerous modifications will readily occur to those skilled in the art. It is not desired to limit the present disclosure or the claims to the exact construction and operation shown or described, and all suitable modifications and equivalents may be resorted to, falling within the scope of the present disclosure.

What is claimed is:

1. A federated currency payment exchange system for at least one of barter currency and digital currency comprising:
a federated electronic trade value transfer system in communication with a point of sale (POS) terminal and a plurality of computing devices associated with a plurality of currency members from at least one of barter currency and digital currency, the federated electronic trade value transfer system stored in at least one memory and executed by at least one processing system to:
receive, from a first computing device associated with a first currency account with at least one of barter currency and digital currency, a first request to perform a first transfer to transfer a specified amount community currency of at least one of barter currency and digital currency from the first currency account to a second currency account associated with a second member;
facilitate transferring of the specified amount of community currency of at least one of barter currency and digital currency according to the first request;
receive, from the first computing device, a second request to perform a second transfer to transfer a specified amount of global currency of at least one of barter currency and digital currency from the first currency account to a global account of at least one of barter currency and digital currency associated with a merchant; and
facilitate transferring of the specified amount of global currency according to the second request;
wherein the global currency is separately and distinctly managed independently of the community currencies.

2. The federated currency payment exchange system of claim 1, wherein the federated electronic trade value transfer system is further executed to identify the first currency account and second currency account, and verify that the transfer of the community currencies is authorized.

3. The federated currency payment exchange system of claim 1, wherein the federated electronic trade value transfer system is further executed to perform at least one of calculating an exchange rate of a current value of the specified amount of community currencies of at least one of barter currency and digital currency to a current value of global currency of at least one of barter currency and digital currency, determining a processing fee or a transaction fee to be assessed to a user for performing the first transfer and the second transfer, verifying that the first transfer has successfully completed prior to initiating the second transfer.

4. The federated currency payment exchange system of claim 1, wherein the POS terminal comprises at least one of an electronic payment device reader, a swipe card reader, an electronic smart card reader, a retinal identification reader, a fingerprint identification reader, an implant chip identification reader, a radio frequency identification reader, and a global positioning system identification reader.

5. The federated currency payment exchange system of claim 1, wherein the POS terminal is configured on a kiosk.

6. The federated currency payment exchange system of claim 1, wherein the trade value transfer system is further executed to communicate with a parasitic currency value software application using at least one of barter currency and digital currency and executed on the POS terminal.

7. The federated currency payment exchange system of claim 6, wherein the federated electronic trade value transfer system is further executed to download a parasitic currency value software application using at least one of barter currency and digital currency to the POS terminal.
